(19) United States
(12) Patent Application Publication
(10) Pub. No.: US 2004/0260540 A1
(43) Pub. Date: Dec. 23, 2004

(54) System and method for spectrogram analysis of an audio signal

(76) Inventor: Tong Zhang, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/465,640

(22) Filed: Jun. 20, 2003

(51) Int. Cl. G10L 19/14

(52) U.S. Cl. 704/205

(57) ABSTRACT

A method and system for analyzing an audio signal through the use of a spectrogram image of the audio signal. A two-dimension spectrogram of the audio portion of a multimedia signal is computed, and one or more morphological operators are applied to the spectrogram to create a spectral peak track image of the audio signal. Application of the morphological operators can extract the spectral peak tracks from background noise of the audio signal to show temporal patterns and spectral distribution of speech and music components of the audio signal. The spectral peak track image is analyzed to distinguish the speech and/or music content of the audio signal.

### BACKGROUND

The number and size of multimedia works, collections, and databases, whether personal or commercial, have grown in recent years with the advent of compact disks, MP3 disks, affordable personal computer and multimedia systems, the Internet, and online media sharing websites. Being able to browse these files and to discern their content is important to users who desire to make listening, cataloguing, indexing, and/or purchasing decisions from a plethora of possible audiovisual works and from databases or collections of many separate audiovisual works.

While audiovisual works can include an audio portion and a visual portion, some content analysis techniques examine only the audio portion of the work under the approach that the audio portion of an audiovisual work can be distinctive of the work itself. One technique for analyzing an audiovisual work is discussed in Kenichi Minami, et al., Video Handling with Music and Speech Detection, IEEE MULTIMEDIA, July-September 1998 at 17-25, the contents of which are incorporated herein by reference. Minami's technique for indexing a videotape detects music and speech portions of the work through application of an edge detection algorithm to identify peaks in a spectrogram of the sound on the video.

### SUMMARY

Exemplary embodiments are directed to a method and system for spectrogram analysis of an audio signal, including receiving an audio signal to be analyzed; computing a two dimension spectrogram of the audio signal; and applying at least one morphological operator to the spectrogram to create a spectral peak track image of the audio signal.

An additional embodiment is directed toward a method for spectrogram analysis of an audio signal, including receiving an audio signal; computing a two dimension spectrogram of the audio signal; applying at least one morphological operator to the spectrogram, wherein the spectrogram is comprised of one or more spectral peak tracks; and analyzing the spectral peak tracks to detect music and/or speech components of the audio signal.

Alternative embodiments provide for a computer-based system for spectrogram analysis of an audio signal, including a device configured to record an audio signal; and a computer configured to compute a two dimension spectrogram of the recorded audio signal; apply at least one morphological operator to the spectrogram to create a spectral peak track image of the audio signal; and analyze the spectral peak track image to distinguish components of the audio signal.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements, and:

FIG. 1 shows a component diagram of a system for spectrogram analysis of an audio signal in accordance with an exemplary embodiment of the invention.

FIG. 2 shows a block flow chart of an exemplary method for spectrogram analysis of an audio signal.

FIG. 3, consisting of FIGS. 3(a)-(e), shows spectrograms of an exemplary audio signal produced by a trumpet as successively modified by morphological operators.

FIG. 4 shows a block flow chart of an exemplary method for spectrogram analysis of an audio signal.

FIG. 5 shows a block flow chart of an exemplary method for spectrogram analysis of an audio signal.

FIG. 6, consisting of FIGS. 6(a)-(b), shows a spectrogram of an exemplary sequence of audio signals produced by a horn as modified by morphological operators.

FIG. 7, consisting of FIG. 7(a)-(b), shows a spectrogram of an exemplary sequence of audio signals produced by human speech as modified by morphological operators.

FIG. 8 shows a larger view of the binary image of FIG. 6(b).

FIG. 9 shows a larger view of the binary image of FIG. 7(b).

FIG. 10 shows an exemplary histogram of a gray scale image for use by an adaptive thresholding morphological operator.

### DETAILED DESCRIPTION OF THE PREFERRED EMBODIMENTS

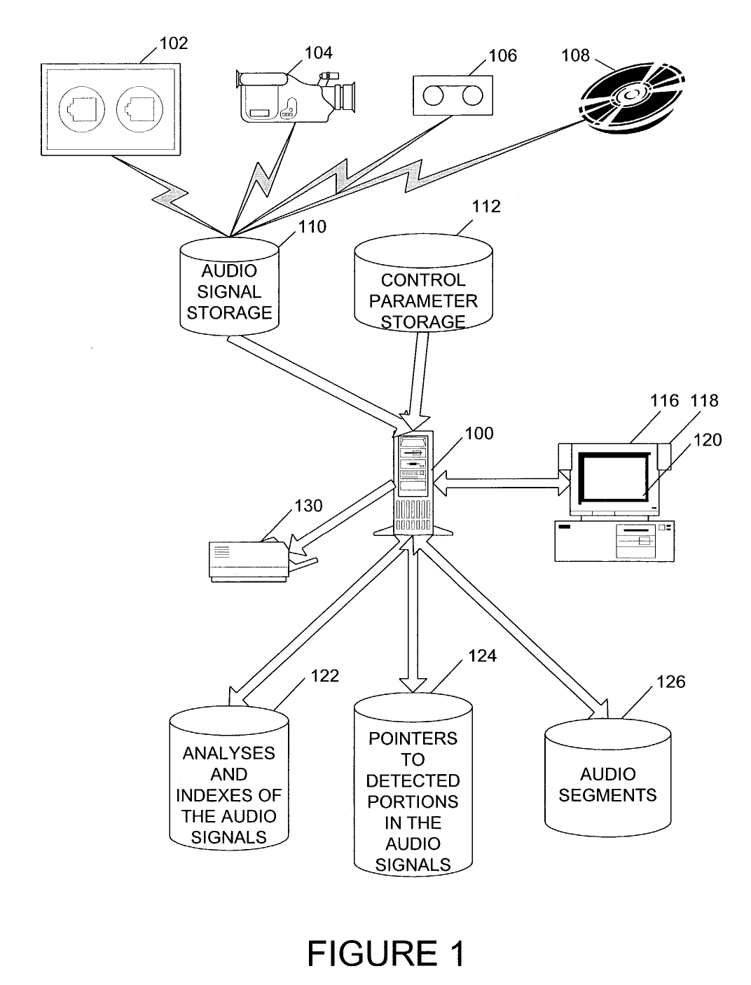

FIG. 1 illustrates a computer-based system for spectrogram analysis of audio signals according to an exemplary embodiment. The term, “audio signals,” as used herein is intended to refer to any electronic form of sound, including both analog and digital representations of sound, that can be reviewed for analyzing the content of the sound information. The audio signals being analyzed by exemplary embodiments can include, for purposes of explanation and not limitation, a full audio track of a song, a partial rendition of a musical piece, multiple musical works combined together, a speech, or a combination of sounds including music, speech, and background noise. The frequency range of the audio signals is not limited to the range audible to the human ear.

FIG. 1 shows a recording device such as a tape recorder 102 configured to record an audio track. Alternatively, any number of recording devices, such as a video camera 104, can be used to capture an electronic track of sounds, including singing and instrumental music. The resultant recorded audio track can be stored on such media as cassette tapes 106 and/or CD's 108. For the convenience of processing the audio signals, the audio signals can also be stored in a memory or on a storage device 110 to be subsequently processed by a computer 100 comprising one or more processors.

Exemplary embodiments are compatible with various networks, including the Internet, whereby the audio signals can be downloaded for processing on the computer 100. The resultant output audio analysis can be uploaded across the network for subsequent storage and/or browsing by a user who is situated remotely from the computer 100.

The one or more audio tracks comprising audio signals are input to a processor in a computer 100 according to exemplary embodiments. The processor in the computer 100 can be a single processor or can be multiple processors, such as first, second, and third processors, each processor adapted by software or instructions of exemplary embodiments for performing spectrogram analysis of an audio signal. The multiple processors can be integrated within the computer 100 or can be configured in separate computers which are not shown in FIG. 1. The computer 100 can include a computer-readable medium encoded with software or instructions for controlling and directing processing on the computer 100 for analyzing a spectrogram representation of audio signals.

The computer 100 can include a display, graphical user interface, personal computer 116 or the like for controlling the processing, for viewing the results on a monitor 120, and/or listening to all or a portion of the audio signals over the speakers 118. Audio signals are input to the computer 100 from a source of sound as captured by one or more recorders 102, cameras 104, or the like and/or from a prior recording of a sound-generating event stored on a medium such as a tape 106 or CD 108. While FIG. 1 shows the audio signals from the recorder 102, the camera 104, the tape 106, and the CD 108 being stored on an audio signal storage medium 110 prior to being input to the computer 100 for processing, the audio signals can also be input to the computer 100 directly from any of these devices without detracting from the features of exemplary embodiments. The media upon which the audio signals is recorded can be any known analog or digital media and can include transmission of the audio signals from the site of the event to the site of the audio signal storage 110 and/or the computer 100.

Embodiments can also be implemented within the recorder 102 or camera 104 themselves so that the audio signals can be generated concurrently with, or shortly after, the sound or musical event being recorded. Further, exemplary embodiments of the spectrogram analysis system can be implemented in electronic devices other than the computer 100 without detracting from the features of the system. For example, and not limitation, embodiments can be implemented in one or more components of an entertainment system, such as in a CD/VCD/DVD player, a VCR recorder/player, etc. In such configurations, embodiments of the spectrogram analysis system can generate audio indexing prior to or concurrent with the playing of the audio signal.

The computer 100 accepts as parameters one or more variables for controlling the processing of exemplary embodiments. As will be explained in more detail below, exemplary embodiments can apply one or more morphological operators to a spectrogram and binary image of the audio signals to transform the signals and images into a form to facilitate the detection of music and speech components of the audio signals. The application of mathematical morphology to image analysis for purpose of revealing the spatial aspects of the imaged object is described in J. Serra, Chapter I, Principles—Criteria—Models, in IMAGE ANALYSIS AND MATHEMATICAL MORPHOLOGY 3-33 (1982), the contents of which are incorporated herein by reference. The use of morphological operators is discussed in Henk J. A. M. Heijmans, Chapter 1, First Principles, in MORPHOLOGICAL IMAGE OPERATORS 1-16 (1994) and William K. Pratt, Chapter 15, Morphological Image Processing, in DIGITAL IMAGE PROCESSING 449-90 (2^{nd} Ed. 1991), the contents of each of which are incorporated herein by reference.

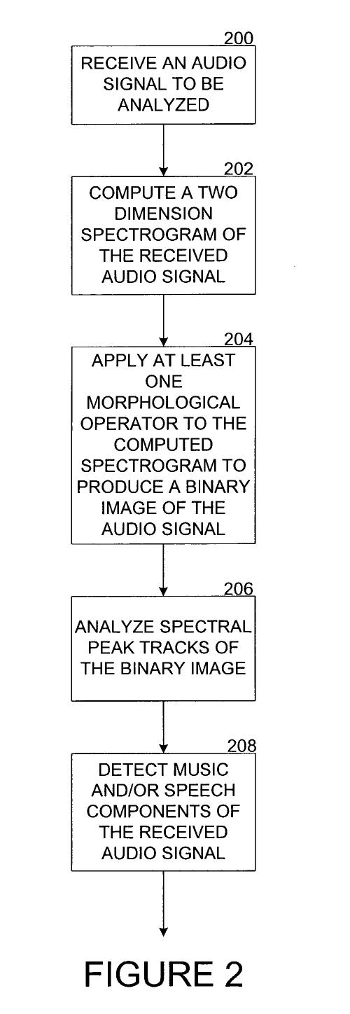

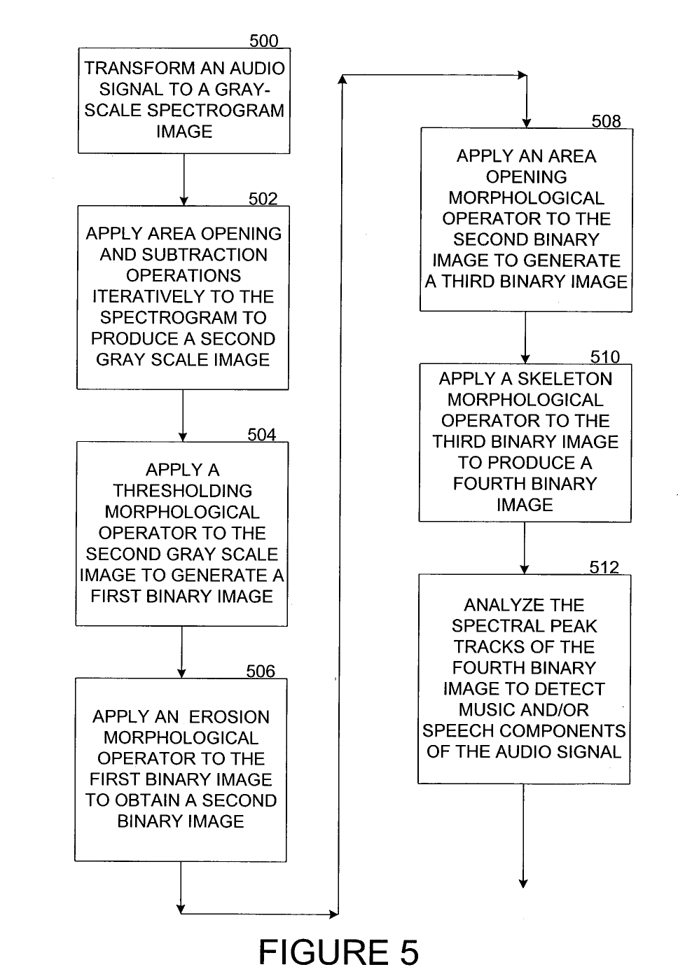

Parameters and algorithms associated with the morphological operators can be retained on and accessed from storage 112. For example, a user can select, by means of the computer or graphical user interface 116, a plurality of morphological operators and/or associated morphological parameters and algorithms from storage 112 to apply to received audio signals to produce, as shown in FIG. 6, a binary image of the audio signals that can facilitate the detection of spectral peak tracks that are indicative of music and speech components of the signals. While these control parameters are shown as residing on storage device 112, this control information can also reside in memory of the computer 100 or in alternative storage media without detracting from the features of exemplary embodiments. As will be explained in more detail below regarding the processing steps shown in FIG. 2, exemplary embodiments utilize selected and default control parameters to morphologically process the audio signals and to store the results of the analysis, including extracted audio portions, on one or more storage devices 122 and 126. In an alternative embodiment, pointers to various audio features detected within the audio signals are mapped to the detected locations in the audio signals or on the audio track, and the pointer information is stored on a storage device 124 along with corresponding lengths for the detected audio features. The processor operating under control of exemplary embodiments further outputs audio segments for storage on storage device 126. Additionally, the results of the audio analysis process can be output to a printer 130.

While exemplary embodiments are directed toward systems and methods for spectrogram analysis of audio signals of songs, instrumental music, speech, and combinations thereof, embodiments can also be applied to any audio signal or track for generating an analysis or an audio summary of the audio track that can be used to catalog, index, preview, and/or identify the content of the audio information components and signals on the track. For example, a collection or database of songs can be indexed by denoting through analysis by exemplary embodiments the beginning, end, and/or length of the audio signals representative of each song. In such an application, an audio track of a song, which can be recorded on a CD for example, can be input to the computer 100 for analysis of the audio signal. In an exemplary embodiment, the audio signals can be electronic forms of songs, with the songs comprised of human sounds, such as voices and/or singing, and instrumental music. However, the audio signals can be any form of multimedia data, including audiovisual works and non-human sounds, as long as the signals include audio data.

Exemplary embodiments can analyze spectrograms of audio signals of any type of human voice, whether it is spoken, sung, or comprised of non-speech sounds. Embodiments are not limited by the audio content of the audio signals, and the results of the signal analysis can be used to index, catalog, and/or preview various audio recordings and representations. Songs as discussed herein include all or a portion of an audio track, wherein an audio track is understood to be any form of medium or electronic representation for conveying, transmitting, and/or storing a musical composition. For purposes of explanation and not limitation, audio tracks also include tracks on a CD 108, tracks on a tape cassette 106, tracks on a storage device 112, and the transmission of music in electronic form from one device, such as a recorder 102, to another device, such as the computer 100.

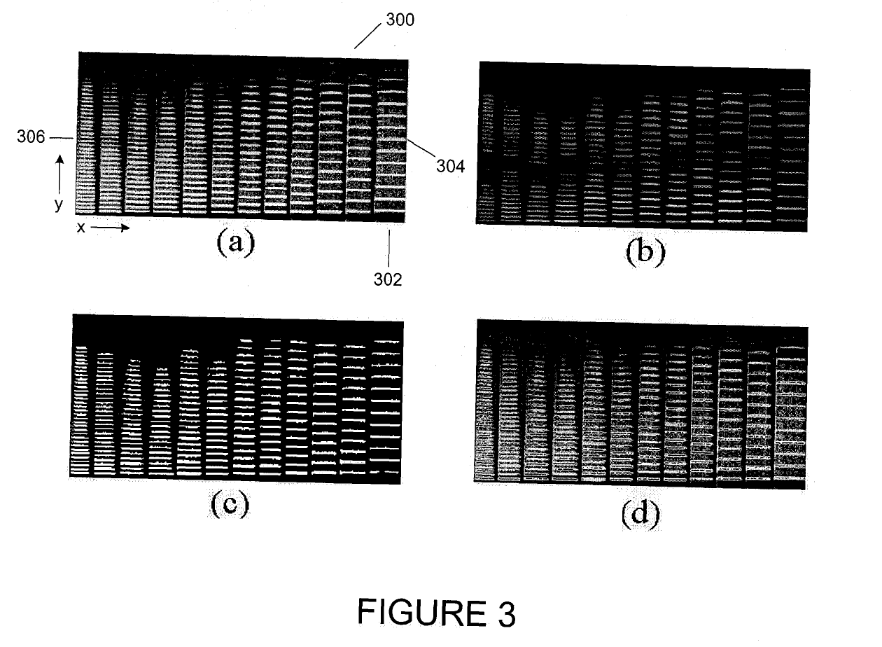

Referring now to FIGS. 1, 2, and 3, a description of an exemplary embodiment of a system for analyzing an audio signal will be presented. FIG. 2 shows a method for spectrogram analysis of an audio signal, beginning at step 200 with the reception of an audio signal of a multimedia work or event, such as a song or a concert, to be analyzed. The received audio signal can comprise a segment of an audio work, the entire work, or a combination of audio segments or audio works. At step 202, a spectrogram of the audio signal is computed, with an exemplary spectrogram 300 being shown in FIG. 3(a). The spectrogram 300 is a two-dimension representation of the audio signal, with the x-axis representing time, or the duration or temporal aspect of the audio signal, and the y-axis representing the frequencies of the audio signal. The exemplary spectrogram 300 represents an audio signal comprised of twelve contiguous notes with different pitches produced by a trumpet, with each note represented by a single column 302 of multiple bars 304. Each bar 304 of the spectrogram 300 is a spectral peak track representing the audio signal of a particular, fixed pitch or frequency 306 of a note across a contiguous span of time, i.e. the temporal duration of the note. Each audio bar 304 can also be termed a “partial” in that the audio bar 304 represents a finite portion of the note or sound within an audio signal. The column 302 of partials 304 at a given time represents the frequencies of a note in the audio signal at that interval of time.

The luminance of each pixel in the partials 304 represents the amplitude or energy of the audio signal at the corresponding time and frequency. For example, under a gray-scale image pattern, a whiter pixel represents an element with higher energy, and a darker pixel represents a lower energy element. Accordingly, under a gray scale imaging, the brighter a partial 304 is, the more energy the audio signal has at that point in time and frequency. The energy can be perceived in one embodiment as the volume of the note.

At step 204, exemplary embodiments of the audio signal analysis system apply at least one morphological operator to the spectrogram to produce a binary image of the audio signal. Application of one or more morphological operators to the spectrogram can screen the effects of noise, adverse acoustics, and overlapping frequencies from the audio signal to reveal characteristics of the audio signal, such as temporal and spectral patterns, which may be helpful for categorizing and/or indexing the signal.

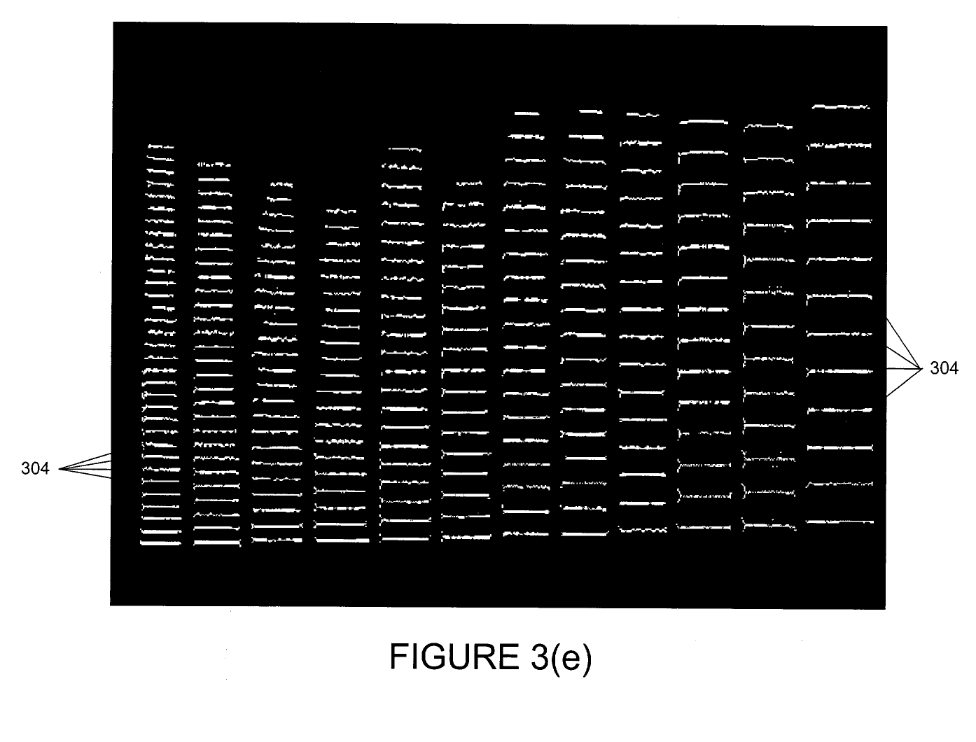

The binary image of the audio signal produced in step 204, including the spectral peak tracks of the image, are analyzed in step 206 to detect, in step 208, the music and/or speech components of the audio signal. While the system can be configured to apply a single default morphological operator, such as a skeleton operator, to the spectrogram 300, a user of the system can also select a plurality of morphological operators to apply in a particular sequence, repetitively, and/or iteratively to the spectrogram 300 of the audio signal. For example, and referring additionally to the flowchart shown in FIG. 4, an audio signal to be analyzed is received at step 400 and a spectrogram 300 of the audio signal is computed at step 402. At step 404 an operator can select, for example, an area opening operator and a subtraction operator from the control parameter storage 112 to apply to the computed spectrogram 300. The result of the area opening and subtraction morphological operations on the spectrogram of FIG. 3(a) is shown in the gray scale image of FIG. 3(b). The operator can then select in step 406, for example, a thresholding operator, an erosion operator, and an area opening operator from control parameter storage 112 to apply to the gray scale image shown in FIG. 3(b), thereby creating a first binary image, as represented by FIG. 3(c). The thresholding operator selected can be, for example, an adaptive thresholding operator, but the embodiment is not so limited.

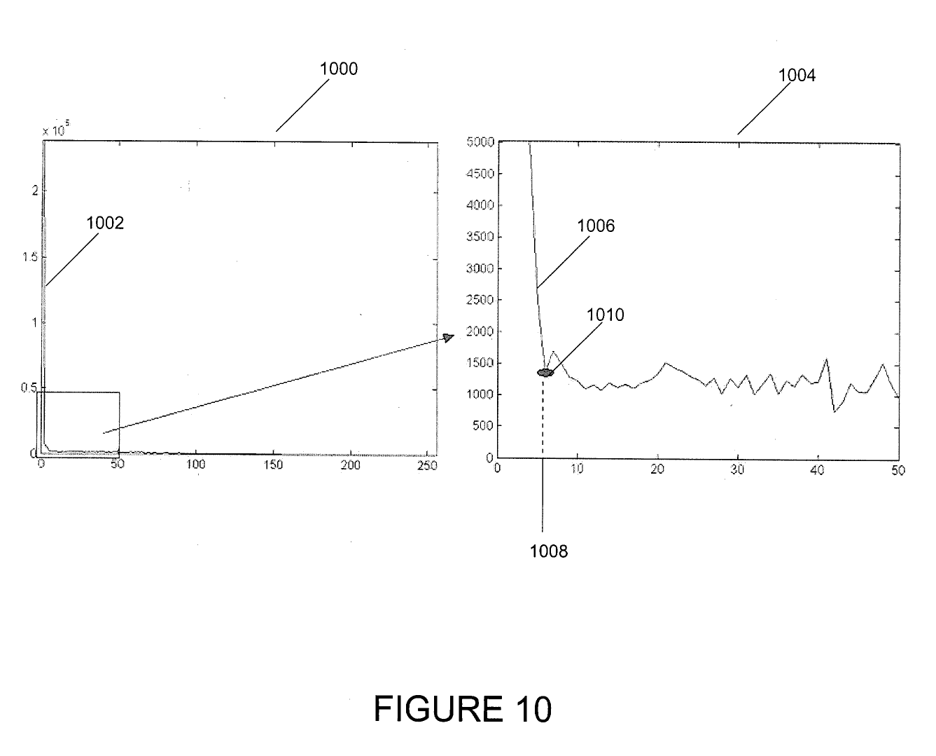

Referring briefly to FIG. 10, there is shown an exemplary histogram of the gray scale image represented by FIG. 3(b). The x-axis of the two plots in FIG. 10 represent the luminance, or intensity, of the pixels in the gray scale image of the audio signal, with zero representing black. A relative luminance value range from 0 to 255, as shown in the graph 1000 on the left, permits representation of the luminance value for a pixel with a single byte of data, but the embodiment is not limited to a single byte nor a maximum value of 255. The y-axis is numeric and represents the number of pixels in the image with a corresponding luminance value along the x-axis. The luminance graph line 1002 shows the allocation of pixel luminance across the luminance value range of 0 to 255. The propensity of values in the low luminance range shows that many of the pixels in the gray scale image are black or very dim. The graph 1004 on the right shows the same luminance graph 1006, but with an expanded scale which more graphically shows the greater allocation of pixels in the relatively low luminance range. A threshold can be selected as equal to the x-axis value 1008 of a first minimum value 1010 in the graph, which is shown to be approximately 6 in this example. All pixels with a luminance higher than the value 1008 can be assigned a value of 1, while all other pixels are assigned a value of zero. In this manner, the gray scale image can be transformed to a binary image according to adaptive thresholding.

This morphological development process continues in step 408 with the selection of a skeleton morphological operator from control parameter storage 112 and applying the skeleton morphological operator to the first binary image to produce a second binary image of the received audio signals as represented by FIG. 3(d). FIG. 3(e) shows a larger view of the binary image of FIG. 3(d), showing the spectral peak tracks 304 of the audio signal. The spectral peak tracks of the second binary image are analyzed in step 410, and the music and/or speech components of the audio tracts are detected in step 412 from this analysis. With exemplary embodiments, speech and music components of the audio signal can be distinguished from each other and from other components of the audio signal. A speech/music detector can be applied to the final binary image of the audio signal to detect and optionally analyze the speech and/or music components involved in the audio signal. For example, if the frequency levels of the spectral peak tracks are stable across several intervals, the audio signal at that moment is probably music. On the other hand, if the estimated pitch value of the spectral peak tracks is in the 100-350 Hz range and if the frequencies of the spectral peak tracks change gradually over time, the signal is likely from human speech.

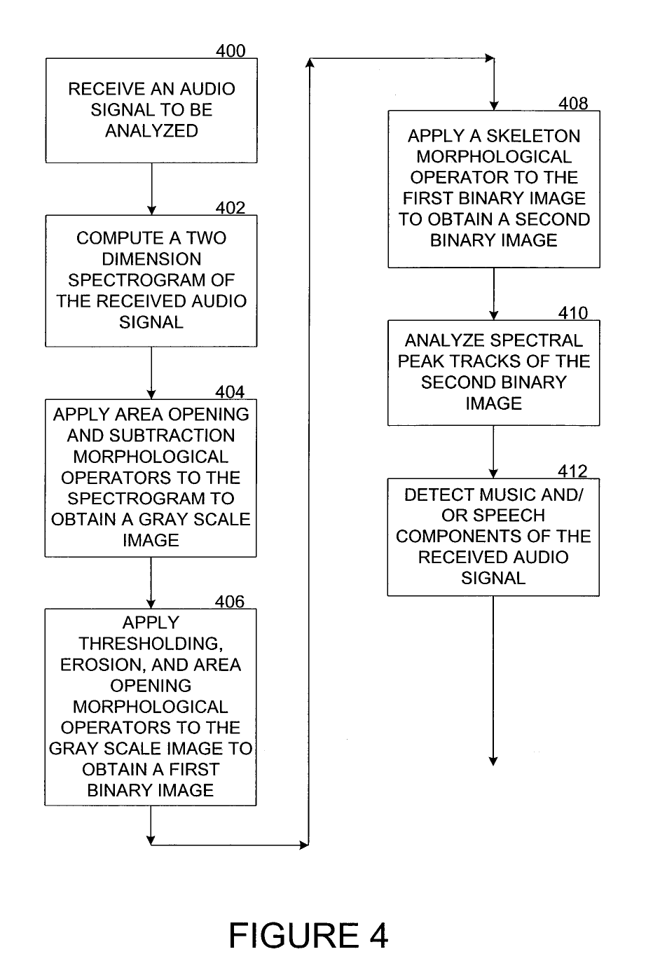

Exemplary embodiments also provide for the automatic, successive application of a predetermined sequence of multiple morphological operators to the spectrogram and the resultant binary images to analyze and subsequently detect the audio content of particular audio signals. Selection of particular morphological operators can control which audio indicators and/or speech and music patterns in the audio signal will be emphasized and, accordingly, can be more easily detected from the resultant binary images. Alternately, one or more morphological operators can be applied iteratively until a desired result or pattern is achieved, thereby facilitating the analysis and detection of the audio components. For example, one exemplary application of the spectrogram analysis system is shown in FIG. 5, beginning with the transformation of an audio signal to a gray scale spectrogram image at step 500. At step 502, area opening and subtraction morphological operations are applied iteratively one or more times to the spectrogram to produce a second gray scale image. A thresholding operator, such as an adaptive thresholding operator, is applied to the second gray scale image at step 504 to generate a first binary image. An erosion morphological operator is applied to the first binary image at step 506 to obtain a second binary image, and at step 508 an area opening operator is applied to the second binary image to generate a third binary image. At step 510, a skeleton operation is performed on the third binary image, producing a fourth binary image. The successive application of the morphological operators as shown in steps 502-510 can extract the spectral peak tracks from background noise of the audio signal to show temporal and spectral patterns and distribution of speech and music components of the audio signal. At step 512, the spectral peak tracks of the fourth binary image are analyzed, and the audio components of the signal are detected.

The results of the analysis can be stored on the storage device 122, and pointers to various detected speech and/or music segments in the audio signal can be stored on storage device 124 for subsequent access to and use or analysis of the audio signal. The detected audio segments can be stored on the storage device 126.

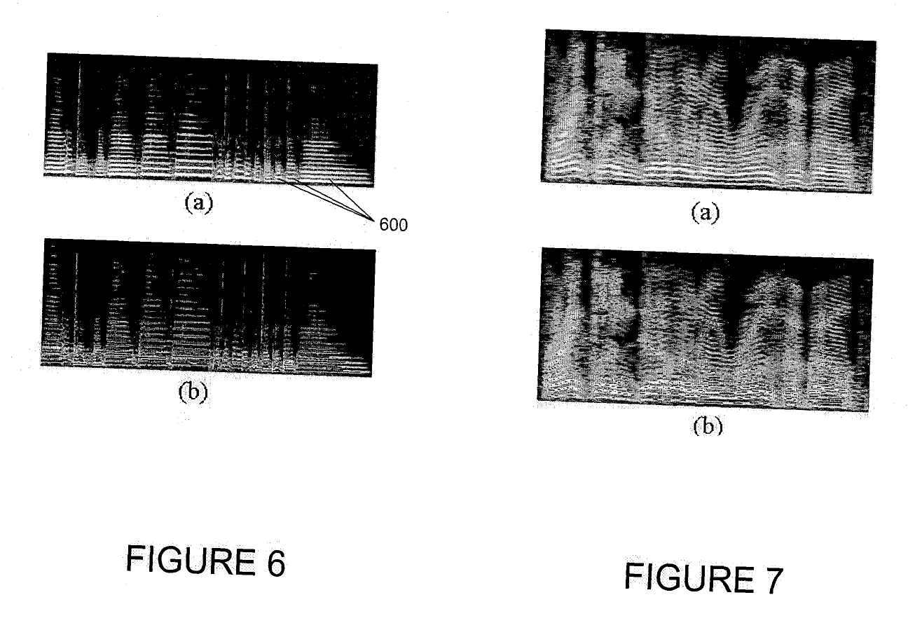

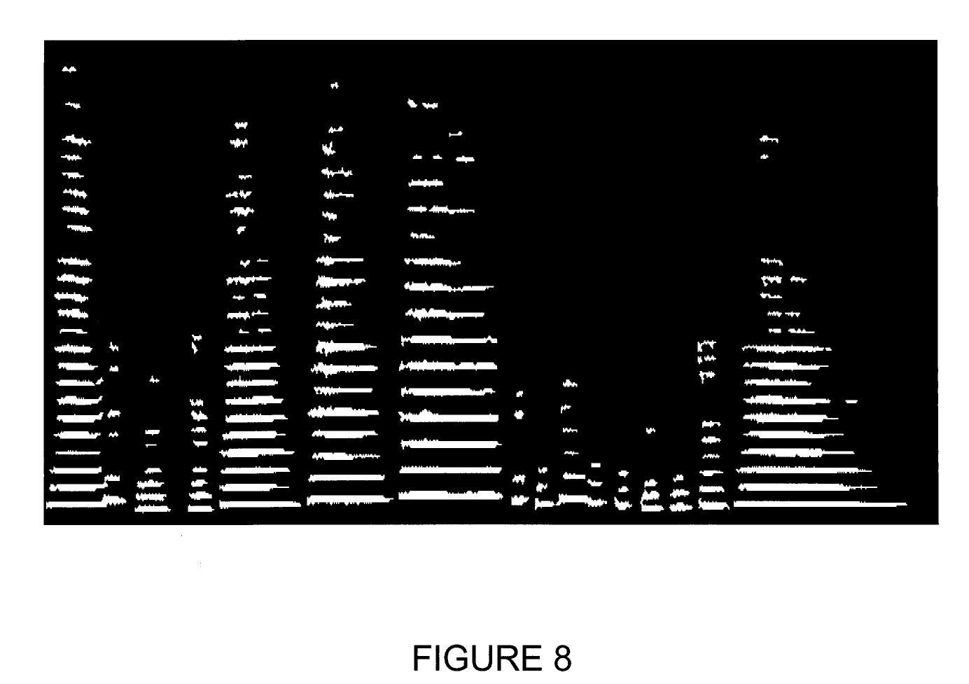

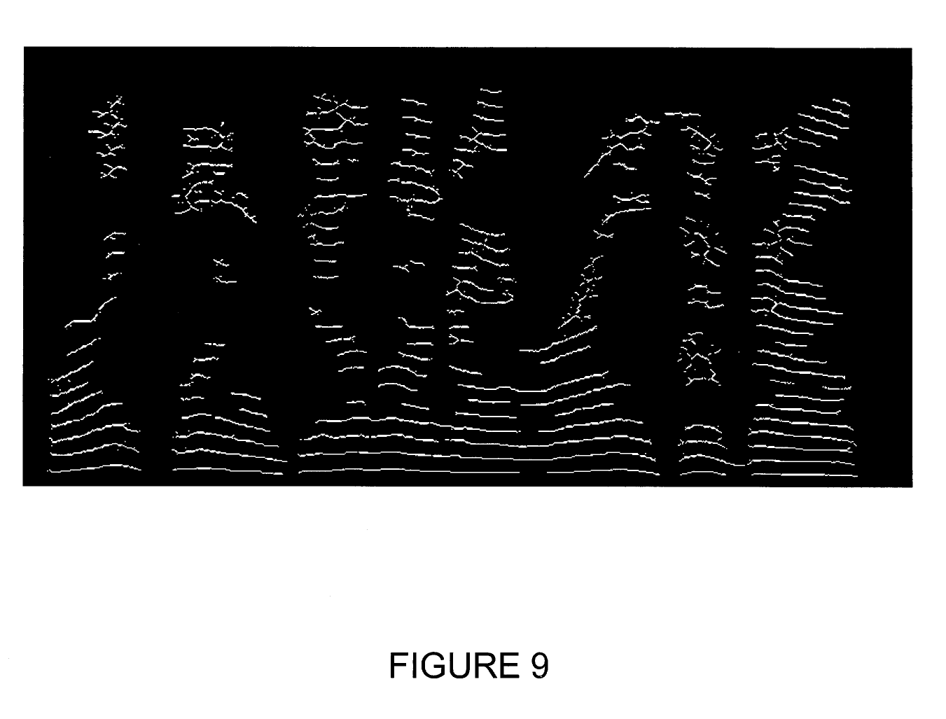

Referring now to FIG. 6, there is shown in FIG. 6(a) the spectrogram of a sixteen note audio signal from a horn. The varying temporal footprint of the notes can be detected by the different widths of the columns 600. FIG. 6(b) represents the binary image of the horn's audio signal after a series of morphological operators have been applied to the spectrogram. FIG. 6(b) is shown in greater detail in the larger view presented in FIG. 8. FIG. 7 is similar to FIG. 6, but represents the two-dimensional images of a human speech audio signal. Correspondingly, FIG. 9 shows the binary image of FIG. 7(b) in more detail. As can be seen from comparing FIGS. 8 and 9, the spectral peak tracks in speech are different from those of a music signal and are not fixed at particular frequencies. As discussed above, the pitch of the human voice is generally in the range of 100 to 350 Hz, a fact that can be utilized in the analysis and detection steps 410 and 412 to determine the content of the audio signal.

Although preferred embodiments of the present invention have been shown and described, it will be appreciated by those skilled in the art that changes may be made in these embodiments without departing from the principle and spirit of the invention, the scope of which is defined in the appended claims and their equivalents.

What is claimed is:

1. A method for spectrogram analysis of an audio signal, comprising:
receiving an audio signal to be analyzed;
computing a two dimension spectrogram of the audio signal; and
applying at least one morphological operator to the spectrogram to create a spectral peak track image of the audio signal.

2. The method according to claim 1, wherein the audio signal is comprised of at least audio sounds, and wherein the audio sounds can include one or more of music, speech, and non-human sounds.

3. The method according to claim 1, wherein the computed spectrogram is comprised of spectral peak tracks, and wherein each spectral peak track represents a sound of a particular frequency and duration.

4. The method according to claim 1, including transforming the computed spectrogram into a gray scale image.

5. The method according to claim 1, wherein the spectrogram is transformed by the application of the at least one morphological operator.

6. The method according to claim 5, wherein a plurality of morphological operators are successively applied to the spectrogram to obtain the transformed spectrogram.

7. The method according to claim 6, wherein the plurality of morphological operators are selected from a list of morphological operators including area opening, subtraction, adaptive threshold, erosion, dilation, and skeleton.

8. The method according to claim 1, including processing the audio signal by analyzing the spectral peak track image to distinguish speech and/or music.

9. The method according to claim 1, including applying the at least one morphological operator to extract the spectral peak tracks of the audio signal to show temporal and spectral patterns of the audio components of the received signal.

10. The method according to claim 1, comprising:
transforming the computed spectrogram into a gray scale image;
applying area opening and subtraction morphological operators to the spectrogram to obtain a second gray scale image;
applying thresholding, erosion, and area opening morphological operators to the second gray scale image to obtain a first binary image;
applying a skeleton morphological operator to the first binary image to obtain a second binary image; and
analyzing spectral peak tracks of the second binary image to detect occurrences of music and speech.

11. A method for spectrogram analysis of an audio signal, comprising:
receiving an audio signal;
computing a two dimension spectrogram of the audio signal;
applying at least one morphological operator to the spectrogram, wherein the spectrogram is comprised of one or more spectral peak tracks; and
analyzing the spectral peak tracks to detect music and/or speech components of the audio signal.

12. The method according to claim 11, wherein the spectrogram is a gray-scale image of the audio signal.

13. A computer-based system for spectrogram analysis of an audio signal, comprising:
a device configured to record an audio signal; and
a computer configured to:
compute a two dimension spectrogram of the recorded audio signal;
apply at least one morphological operator to the spectrogram to create a spectral peak track image of the audio signal; and
analyze the spectral peak track image to distinguish components of the audio signal.
